(19) United States
(12) Patent Application Publication
(10) Pub. No.: US 2005/0057442 A1
(43) Pub. Date: Mar. 17, 2005

(54) Adjacent display of sequential sub-images

(76) Inventor: Olan Way, Eugene, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,167

(22) Filed: Aug. 28, 2003

(51) Int. Cl. G09G 5/00

(52) U.S. Cl. 345/9

(57) ABSTRACT

An adjacent display of sequential sub-images is described such that each sub-image appears simultaneously to the human eye. In one embodiment of the present invention, a display device includes an image forming device and a mirror assembly. The image forming device is configured to provide sequential sub-images that compose at least a portion of an image. The mirror assembly is configured to provide an adjacent display of the sequential sub-images, one to another, such that each sub-image in the portion of the image appears simultaneously to the human eye.

### TECHNICAL FIELD

The present invention generally relates to the field of image display and more particularly to an adjacent display of sequential sub-images.

### BACKGROUND

Projection devices are utilized in many aspects of modern life. From home theaters to business presentations, projection devices are provided to offer a wide range of functionality to consumers. For example, a projection device may be included in a projector to provide a display of a slide show on a screen. A projection device may also be included in a rear-projection television to display television programming, movies and games.

To provide a display of a desired size, the projection device is positioned at a distance from the display. To increase the size of the display, the distance between the screen and the projection device is increased. The perceptibility of the display, however, may decrease at distances that are closer to the display due to the increase in the size of the display. For example, even though the number of pixels that are output by the projection device may remain the same at varying distances, the number of pixels in a given area may decrease. Therefore, as the display is made larger, a viewer of the display may have to move away from the display to view the display.

Additionally, the positioning of the projection device at the distance that provides a display of a desired size may result in an increase in the size of the projection system that includes the projection device. For example, a projection system configured as a rear-projection television may include a projection device to display an image on a screen. As the size of the display increases, the projection device is positioned at a greater distance from the screen, which may result in a larger rear-projection television.

Therefore, it would be an advance in the art to provide projection of a display for increased size and/or resolution that may be provided at closer distances to a screen.

### BRIEF DESCRIPTION OF THE DRAWINGS

FIG. 1 is an illustration of an exemplary embodiment of the present invention that shows a projection system that includes a projection device that provides an output for display on a screen.

FIG. 2 is an illustration of an exemplary embodiment of the present invention showing a display device which includes the projection device and the screen seen in FIG. 1 to provide an adjacent sequential display of first and second sub-images that compose an image.

FIG. 3 is an illustration of an exemplary embodiment of the present invention showing a cross-sectional view of portions of the display device of FIG. 2.

FIG. 4 is an illustration of an exemplary embodiment of the present invention showing the projection device and the mirror assembly seen in FIG. 3 as including a rotating mirror device.

FIG. 5 is an illustration of an exemplary embodiment of the present invention showing the projection device and a mirror assembly of FIG. 3 as including a mirror device having reflective and transparent states.

FIG. 6 is an illustration of an exemplary embodiment of the present invention showing the projection device and a mirror assembly of FIG. 3 as including a moving mirror that is movable between first and second positions.

FIG. 7 is an illustration of an exemplary embodiment of the present invention showing first and second sub-images having a first resolution that provide an image composed of the first and second sub-images that has a second resolution that is higher than the first resolution.

FIG. 8 is an illustration of an exemplary embodiment of the present invention showing first and second sub-images each having an aspect ratio and resolution that are utilized to provide an image composed of the sub-images having a different aspect ratio and resolution than each of the first and second sub-images.

FIG. 9 is an illustration of an exemplary embodiment of the present invention showing a plurality of projection devices each providing an adjacent display of sequential sub-images to provide a single image.

FIG. 10 is a flow chart depicting a procedure of an exemplary embodiment of the present invention wherein a projection device is produced that provides an adjacent and sequential display of sub-images.

The same reference numbers are used throughout the drawings to reference like features and components.

### DETAILED DESCRIPTION

OVERVIEW

An adjacent display of sequential sub-images is described. In one embodiment of the present invention, a display device includes an image forming device and a mirror assembly. The image forming device is configured to provide sequential sub-images that compose at least a portion of an image. The mirror assembly is configured to provide an adjacent display of the sequential sub-images, one to another, such that each sub-image in the portion of the image appears simultaneously to the human eye

In an additional embodiment of the present invention, a method is described in which a projection device displays an image. The projection device includes an image forming device and a mirror assembly. The image forming device is configured to provide first and second sequential sub-images that compose the image. The mirror assembly is configured to provide sequential adjacent display of the first and second sequential sub-images. The first sequential sub-image is displayed by the mirror assembly on a first portion of a screen. The second sequential sub-image is displayed by the mirror assembly on a second portion of the screen that is adjacent to the first portion. The first and second sub-images are displayed by the mirror assembly such that the image is viewable by the human eye.

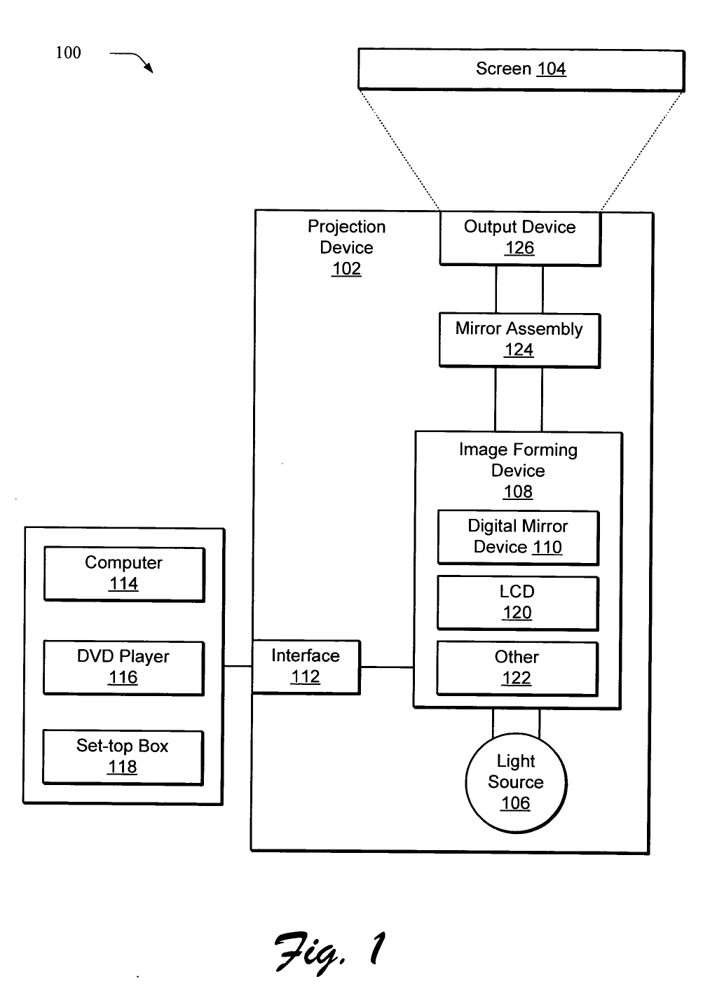

FIGS. 1-6 and 9 illustrate exemplary embodiments of projection devices. The projection devices in each embodiment of the present invention may be configured for use in a variety of settings, such as a front-projector in a home theater for display of a television program, as a mobile projector for display of a slide-show presentation in an office, as a movie projector for display of a movie in a movie theater, as a rear-projection television, and so on.

FIG. 1 is an illustration of an exemplary embodiment of the present invention that shows a projection system 100 that includes a projection device 102 that provides an output for display on a screen 104. The projection device 102 includes a light source 106 that supplies light that is used to provide the output of the projection device 102. The light source 106 may be configured in a variety of ways, such as an arc halogen discharge lamp. Arc halogen discharge lamps do not contain a filament to emit light but rather ionize a gaseous vapor though a high-energy arc discharge between two electrodes. Other light sources may also be utilized, such as an incandescent light bulb, a fluorescent device, a white-light emitting diodes, and so forth.

Light from the light source 106 is directed toward an image forming device 108. The image forming device 108 provides an image using the light from the light source 106. To provide the image, the image forming device 108 may include a variety of components. In one embodiment, the image forming device 108 is configured to perform digital light processing through the use of a digital mirror device 110. The digital mirror device 110 includes a multitude of mirrors that are mounted onto a substrate. The mirrors of the digital mirror device 110 may be rotated individually, which causes each of the mirrors to either reflect or not reflect light from the light source 106.

If a single digital mirror device 110 is utilized, red, green and blue (RGB) portions of an image are shown in sequence to supply a colored image. For example, a color wheel that has red, green and blue (RGB) segments may be utilized to supply the colors. The color wheel is placed between the light source 106 and the digital mirror device 110 and spun to provide red, green or blue light depending on which segment of the color wheel is placed in a pathway of light that is output from the light source 106 to the digital mirror device 110. Configuration of the mirrors on the digital mirror device 110 is synchronized with the placement of the segments of the color wheel in the light path to provide sequential red, green and blue images. By supplying the sequential images in rapid sequence, a full color image is perceived by the human eye. In another embodiment, multiple digital mirror devices are utilized to form an image. For example, separate digital mirror devices may be utilized to provide respective outputs of red, green and blue. Light reflected from each of the separate digital mirror devices is combined to display a full color image.

The mirrors of the digital mirror device 110 may be configured in response to an input received from an interface 112. The input may be supplied to the interface 112 from a variety of devices, such as through a computer 114, a DVD player 116, a set-top box 118, and so forth. For example, the computer 114 may provide an input that causes a slide show to be displayed by the image forming device 108.

In another embodiment of the present invention, the image forming device 108 is configured to include a liquid-crystal display (LCD) 120. For example, the LCD 120 may include a stationary mirror. Light from the light source 106 is transmitted through the LCD 120 and reflected from the stationary mirror to provide an image. The LCD 120 is utilized to control the light reflected from the stationary mirror by controlling transmission of red, green and/or blue light at each pixel of the LCD 120. Like the mirrors of the digital mirror device 110, each pixel of the LCD 120 may be configured in response to input received from the interface 112. Although the image forming device 108 including a digital mirror device 110 and/or an LCD 120 is described, other components 122 may also be utilized in the image forming device 108 to form an image, such as a grating light valve (GLV) or a liquid crystal on silicon (LCOS) device. Although the illustrated projection device 102 shows the image forming device 108 and the light source 106 as separate components, components may be added, combined and/or deleted in various embodiments. For example, the image forming device 108 may be configured as a cathode-ray tube (CRT) that includes a cathode, two or more anodes and a phosphor coated screen from which light is output.

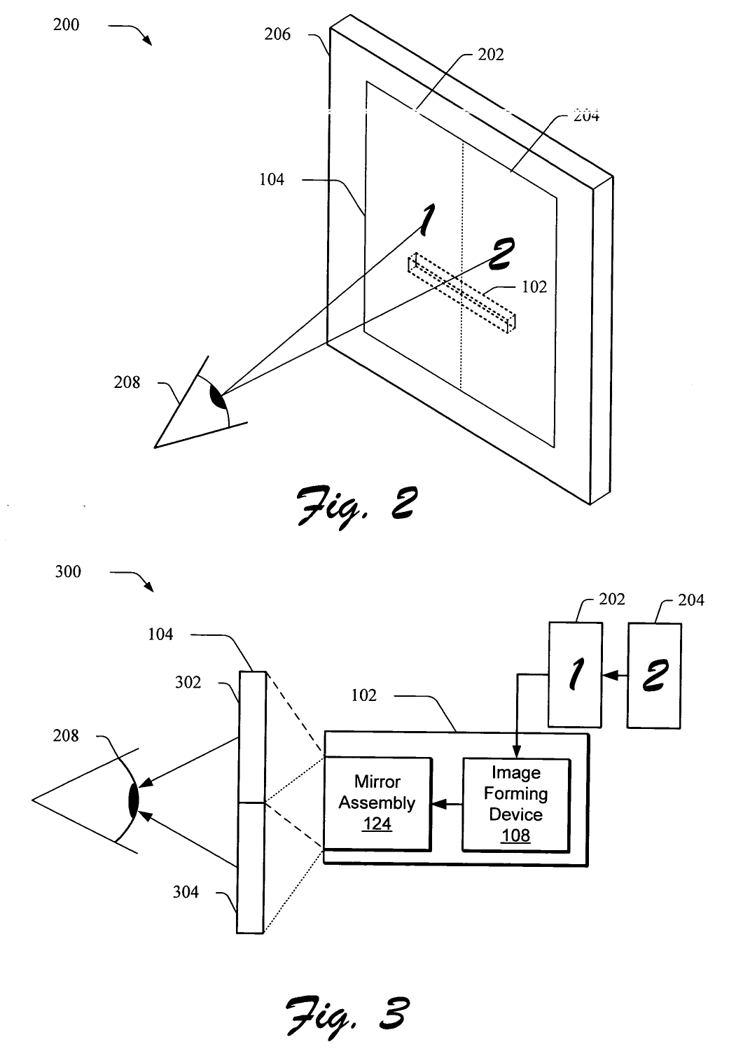

Light is directed (i.e., transmitted, emitted, and/or reflected) by the image forming device 108 to a mirror assembly 124. The mirror assembly 124 provides for an adjacent sequential display of sub-images that compose at least a portion of an image. Through the adjacent sequential display of the sub-images, images may be projected from closer distances, allowing the projection device 102 to be positioned closer to the screen 104. Additionally, a number of pixels provided per unit area may be increased through use of the mirror assembly 124. Further, the mirror assembly 124 may provide a display on the screen 104 that has a greater resolution that the resolution of the image forming device 108. Resolution signifies the number of pixels that are included in an image and/or sub-images. Further description of the image forming device 108 and mirror assembly 124 may be found in the discussion of FIG. 2.

Light that is provided by the image forming device 108 through the mirror assembly 124 is output using an output device 126, such as a lens, one or more mirrors, and so on. Light output by the output device 126 is then displayed on the screen 104 for viewing.

FIG. 2 is an illustration of an exemplary embodiment 200 of the present invention showing a display device 200 which includes the projection device 102 and screen 104 of FIG. 1 to provide an adjacent sequential display of first and second sub-images 202, 204 that compose an image. The projection device 102 is disposed within a housing 206 of the display device 208 and is illustrated in phantom by a dashed box. The screen 104 is attached to the housing 206 such that the output of the projection device 102 is displayed on the screen 104 to be viewable by a human eye 208.

The first sub-image 202 includes a portion of an image that includes a “1”. The second sub-image 204 includes a portion of the image that includes a “2”. The first and second sub-images 202, 204 are displayed adjacent, one to another, by the projection device 102 through use of the mirror assembly 124 (FIG. 1) of the projection device 102. The first and second sub-images 202, 204 are displayed in a sequence, i.e. one after the other, such that each of the first and second sub-images 202, 204 appear simultaneously to the human eye 208. For example, the human eye 208, when viewing the first and second sub-images 202, 204, views the image of the number “12” on the screen 104 due to persistence of the human eye 208 even though the first and second sub-images 202, 204 where output sequentially, and not simultaneously.

The sequential adjacent display of the first and second sub-images 202, 204 is viewed as a single image by the human eye 208 through utilization of two principles of viewing. The first principle is that a “still” may be divided into a collection of pixels that, when viewed by the human eye 208, are interpreted as the still image. Thus, the first and second sub-images 202, 204 may be formed as collections of pixels, e.g. each sub-image has two or more pixels that are viewable by the human eye 208. The second principle is that when a sequence of “still” images is provided in a rapid sequence, the human eye 208 assembles the images into a single moving scene. The projection device 102 utilizes this principle to provide an adjacent sequential display of sub-images to form a still image. The adjacent sequential display of the first and second sub-images 202, 204 is performed at a rate at which the human eye 208 views the first and second sub-images 202, 204 simultaneously. Thus, the still image that is composed of the first and second sub-images 202, 204 is viewed by the human eye 208 as a whole. The projection device 102 may also provide a display of sequential still images to provide a moving scene. For instance, the projection device 102 may first output the first and second sub-images 202, 204 that are viewed as a single still image by the human eye 208. The projection device 102 may then output third and fourth sub-images that are viewed as an additional still image by the human eye 208. The single still image and the additional still image provide the moving scene.

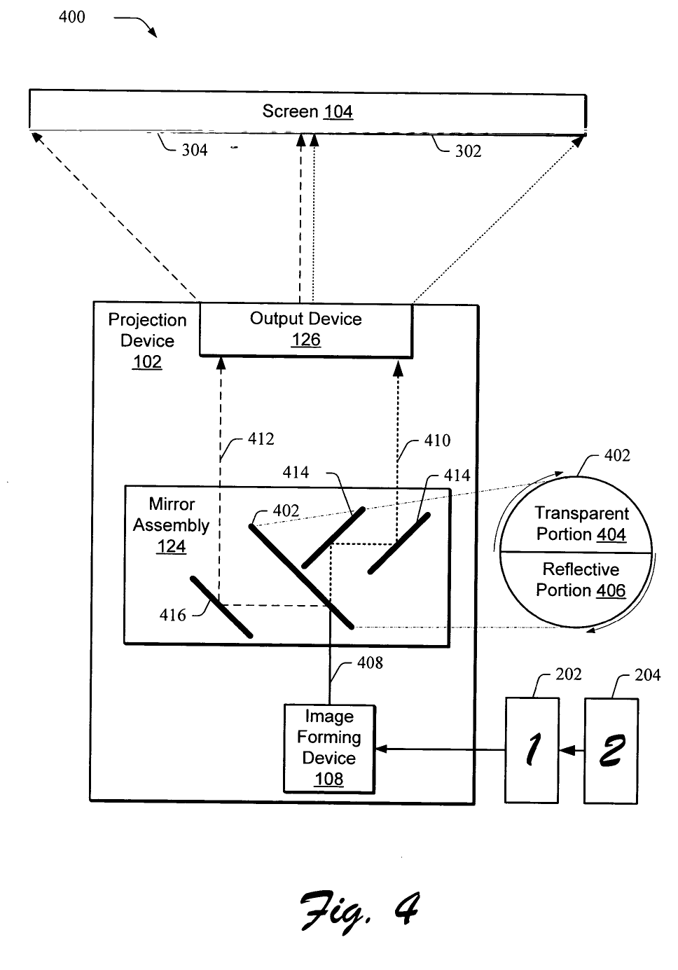

FIG. 3 is an illustration of an exemplary embodiment 300 of the present invention showing a cross-sectional view of portions of the display device 200 of FIG. 2. The projection device 102 includes the mirror assembly 124 and the image forming device 108. The image forming device 108 provides sequential output of the first and second sub-images 202, 204. The mirror assembly 124 is synchronized with the sequential output to provide an adjacent display of the first and second sub-images 202, 204 on respective first and second portions 302, 304 of the screen 104. The synchronization of the adjacent display of sub-images provided by the mirror assembly 124 and the sequential output of the image forming device 108 provide a single still image that is composed of the first and second sub-images 202, 204 when viewed by the human eye 208.

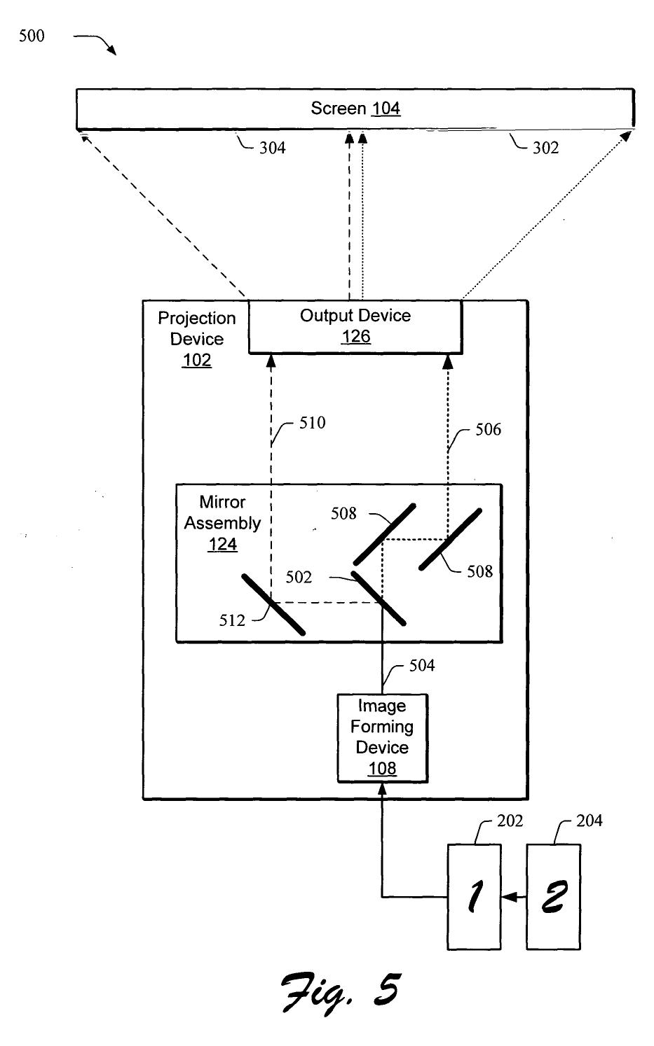

FIGS. 4 through 6 illustrate exemplary embodiments of mirror assemblies 124 that may be included in projection devices 102 as previously described. In variety of projection devices, such as a front-projector, as a mobile projector, as a movie projector, as a rear-projection television, and so on. The mirror assemblies 124 may be configured in a variety of ways, the following embodiments showing some examples thereof.

FIG. 4 is an illustration of an exemplary embodiment 400 of the present invention showing the projection device 102 and mirror assembly 124 of FIG. 3 as including a rotating mirror device 402. Reflection is an optical property that describes the “bouncing” of light off of a surface. The law of reflection states that an angle of incidence equals an angle of reflection. An angle of reflection is an angle between a reflected light wave and a normal drawn at a point of incidence to a reflecting surface.

The mirror assembly 124 has a rotating mirror device 402 that includes a transparent portion 404 and a reflective portion 406. The rotating mirror device 402 is positioned to receive an output, e.g. sequential sub-images, from the image forming device 108. In other words, the rotating mirror device 402 is positioned in an initial pathway 408 of light that is output by the image forming device 108. The mirror assembly 124 provides first and second subsequent pathways 410, 412. Use of the first or second subsequent pathways 410, 412 by light output by the image forming device 108 is controlled depending on whether the transparent portion 404 or the reflective portion 406 is positioned in the initial pathway 408. For example, access to the first subsequent pathway 410 may be provided utilizing one or more mirrors 414. At least one of the mirrors 414 is positioned to reflect light that is transmitted through the transparent portion 404 when the transparent portion 404 is positioned in the initial pathway 408. Light transmitted through the transparent portion 404 is directed by the one or more mirrors 414 at the output device 126 along the first subsequent pathway 410. Light received by the output device 126 from the first subsequent pathway 410 is directed at a first portion 302 of the screen 104. In another embodiment, the first subsequent pathway 410 may be provided without the one or more mirrors 414 by transmitting light directly through the transparent portion 404 to the output device 126.

Access to the second subsequent pathway 412 may also be provided utilizing one or more mirrors 416. At least one of the mirrors 416 is positioned to reflect light that is reflected by the reflective portion 406 of the rotating mirror device 402 when the reflective portion 406 is positioned in the initial pathway 408. Light reflected by the reflective portion 406 is directed by the one or more mirrors 416 at the output device 126 along the second subsequent pathway 412. Light received by the output device 126 from the second subsequent pathway 412 is directed at the second portion 304 of the screen 104.

Rotation of the rotating mirror device 402 is synchronized with the output of the image forming device 108 such that sequential sub-images are displayed adjacent to each other. For example, the image forming device 108 may output the first sub-image 202. The rotating mirror device 402 is positioned such that the transparent portion 404 is placed in the initial pathway 408. Therefore, the first sub-image 202 follows the first subsequent pathway 410 and is displayed on the first portion 302 of the screen 104. The image forming device 108 may then output the second sub-image 204. When the second sub-image 204 is output, the rotating mirror device 402 is positioned such that the reflective portion 406 is placed in the initial pathway 408 through rotation of the rotating mirror device 402. Therefore, the second sub-image 204 follows the second subsequent pathway 412 and is displayed on the second portion 304 of the screen 104.

FIG. 5 is an illustration of an exemplary embodiment 500 of the present invention showing the projection device 102 and mirror assembly 124 of FIG. 3 as including a mirror device 502 having reflective and transparent states. In this embodiment, the mirror device 502 provides control of the use of pathways by light output by the projection device 102 through use of reflective and transparent states.

The mirror device 502 is positioned to receive light output by the image forming device 108 along an initial pathway 504. When the mirror device 502 is in a transparent state, light is transmitted through the mirror device 502 to a first subsequent pathway 506. The first subsequent pathway 506 may include one or mirrors 508 which direct the light at the output device 126. Light received by the output device 126 from the first subsequent pathway 506 is displayed on the first portion 302 of the screen 104.

When the mirror device 502 is in a reflective state, light is reflected by the mirror device 502 to a second subsequent pathway 510. The second subsequent pathway 510 may also include one or mirrors 512 which direct the light at the output device 126. Light received by the output device 126 from the second subsequent pathway 510 is displayed on the second portion 304 of the screen 104. Like the rotating mirror device 402 as described in relation to FIG. 4, the mirror device 502 is synchronized with the sequential output of the first and second sub-images 202, 204 by the image forming device 108. By synchronizing the mirror device 502 with the image forming device 108, the first and second sub-images 202, 204 are displayed on the respective first and second portions 302, 304 of the screen 104 such that a single image that is composed of the first and second sub-images 202, 204 is viewable by a human eye.

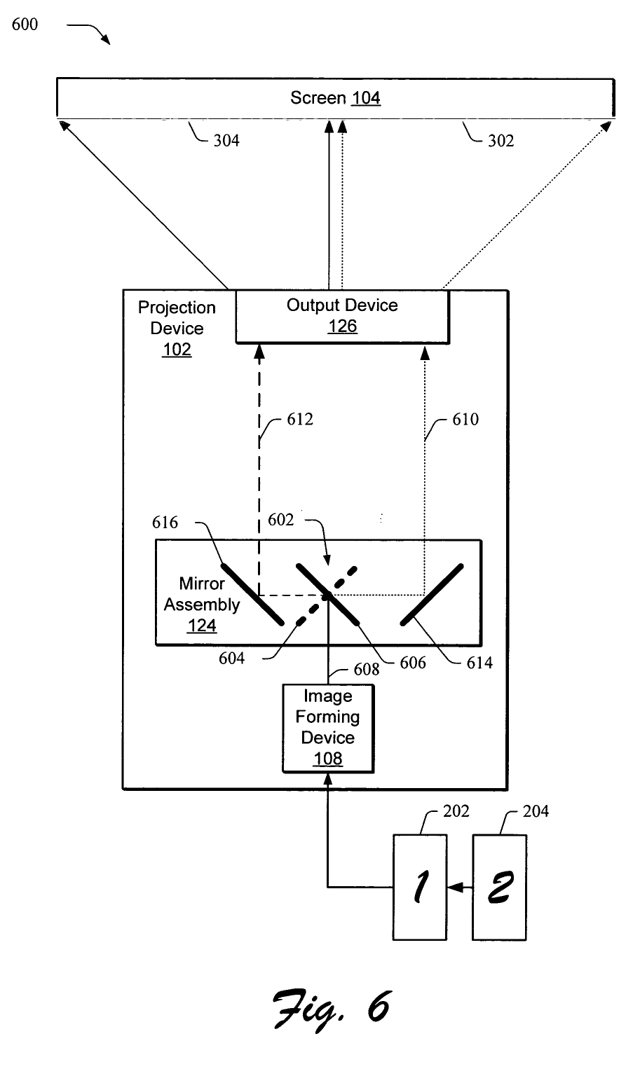

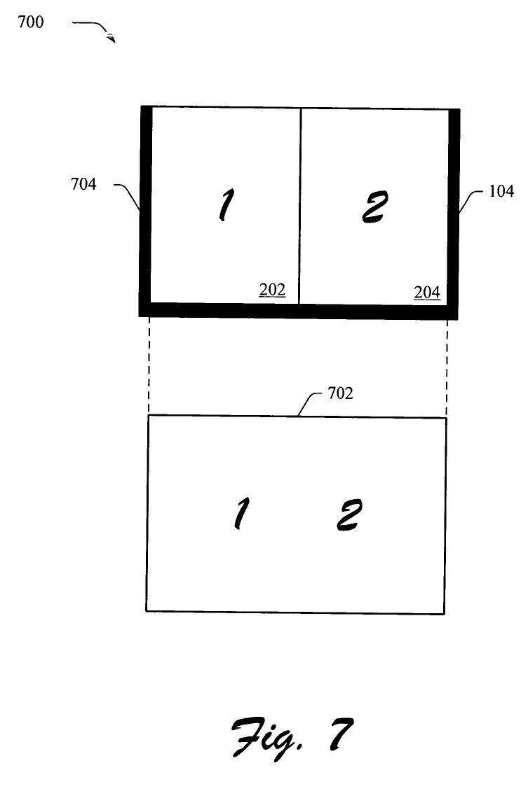

FIG. 6 is an illustration of an exemplary embodiment 600 of the present invention showing the projection device 102 and mirror assembly 124 of FIG. 3 as including a moving mirror 602 that is movable between first and second positions 604, 606. The first position 604 of the movable mirror is shown in FIG. 6 as a dashed line. The second position 606 of the movable mirror is shown in FIG. 6 as a solid line.

The moving mirror 602 is disposed to receive an output, e.g. sequential sub-images, from the image forming device 108. The moving mirror 602 is positioned in an initial pathway 608 of light that is output by the image forming device 108. Through movement of the moving mirror 602, the mirror assembly 124 provides access to the first and second subsequent pathways 610, 612. The first subsequent pathway 610 may be provided utilizing one or more mirrors 614. At least one of the mirrors 614 is positioned to reflect light that is reflected by the moving mirror 602 when in the first position 604. Light reflected by the moving mirror 602 is directed by the one or more mirrors 614 at the output device 126 along the first subsequent pathway 610. Light received by the output device 126 from the first subsequent pathway 610 is directed at a first portion 302 of the screen 104.

The second subsequent pathway 612 may also be provided utilizing one or more mirrors 616. At least one of the mirrors 616 is positioned to reflect light that is reflected by the moving mirror 616 when in the second position 606. Light reflected by the moving mirror 602 is directed by the one or more mirrors 616 at the output device 126 along the second subsequent pathway 612. Light received by the output device 126 from the second subsequent pathway 612 is directed at the second portion 304 of the screen 104.

Movement of the mirror 602 between the first and second positions 604, 606 is synchronized with the sequential output of the first and second sub-images 202, 204 by the image forming device 108. In this way, the first and second sub-images 202, 204 are displayed on the respective first and second portions 302, 304 of the screen 104 such that a single image that is composed of the first and second sub-images 202, 204 is viewable by a human eye.

Although the previous embodiments shown in FIGS. 1, 4, 5 and 6 illustrate the output device 126 as positioned between the mirror assembly 124 and the screen 104, the output device 126 may be repositioned or deleted from the projection device 102. For example, as shown in FIG. 3, the projection device 102 may provide the output from the mirror assembly 124 directly to the screen 104. In another embodiment, the output device 125 is positioned between the image forming device 108 and the mirror assembly 124.

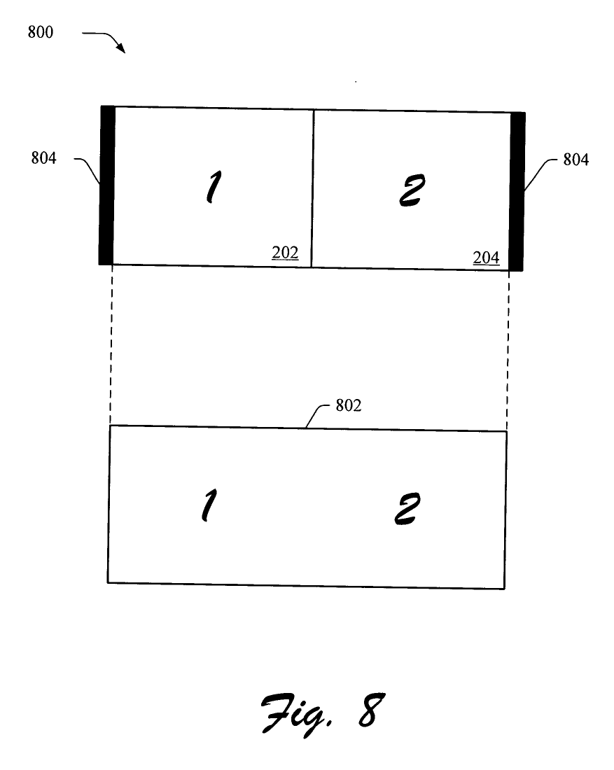

FIG. 7 is an illustration of an exemplary embodiment 700 of the present invention showing each of the first and second sub-images 202, 204 as having a first resolution that provide an image composed of the first and second sub-images that has a second resolution that is higher than the first resolution. As previously stated, resolution signifies the number of pixels that are included in an image and/or sub-images. For example, a system that provides a video graphics array (VGA) resolution in graphics mode supplies a 640-by-480 pixel matrix that is capable of displaying 640 distinct pixels on each of 480 lines, which totals 307,200 pixels. This may translate, however, into different pixels per inch measurements depending on the size of the screen. For example, a 15-inch VGA monitor may display about 50 pixels per inch. A 65-inch rear-projection television, however, may display about 9 pixels per inch when outputting a VGA image.

The projection device 102 discussed in the previous embodiments outputs first and second sub-images 202, 204 which are adjacent, one to another, to form an image 702 that is composed of the first and second sub-images 202, 204. Each of the first and second sub-images 202, 204 has a first resolution. When the first and second sub-images are displayed adjacent to each other, the image 702 that is formed has a higher resolution than the first resolution of the first and/or second sub-images 202, 204. For example, the first and second sub-images 202, 204 each have a super VGA (SVGA) resolution that defines of matrix of pixels that is 800 lines by 600 lines, or 480,000 pixels. The first and second sub-images are displayed adjacent to each other in a rotated 3:4 aspect ratio to form the image 702 in a 4:3 aspect ratio that has an extended graphics array (XGA) resolution. XGA resolution supports a matrix of pixels that is 1024 lines by 768 lines, or 786,432 pixels. The adjacent display of the first and second sub-images 202, 204 may include portions that are not utilized when providing the image 702, which are illustrated by a black portion 704. For example, the first and second sub-images 202, 204, when combined, provide 960,000 pixels. The image 702 in an XGA resolution has 786,432 pixels. Therefore, the unused pixels may be output as the black portion 704 as illustrated in FIG. 7.

Through adjacent display of sub-images provided by the mirror assembly 124, an image may be displayed which has a resolution that is greater than the resolution of the image forming device 108. Thus, image forming devices 108 having lower-resolutions may be utilized to provide high resolution images, e.g. a single SVGA resolution image forming device may supply an XGA resolution. Although VGA, SVGA and XGA resolutions have been described, a variety of other resolutions may also be provided, such as ultra extended graphics array (UXGA) resolution which specifies a 1600 by 1200 resolution, which is approximately 1.9 million pixels, and quantum extended graphic array (QXGA) resolution which specifies a 2048 by 1536 resolution, which is approximately 3.2 million pixels. Although the first and second sub-images 202, 204 are shown as projected adjacent to each other such that the first and second sub-images 202, 204 do not overlap, some overlap may be provided in additional embodiments of the present invention. For example, the first and second sub-images 202, 204 may be output adjacent to each other such that substantial overlap over the first and second sub-images 202, 204 is not encountered, such as approximately half of an area on which the first sub-image 202 is displayed does not overlap more than approximately half of an area on which the second sub-image 204 is displayed.

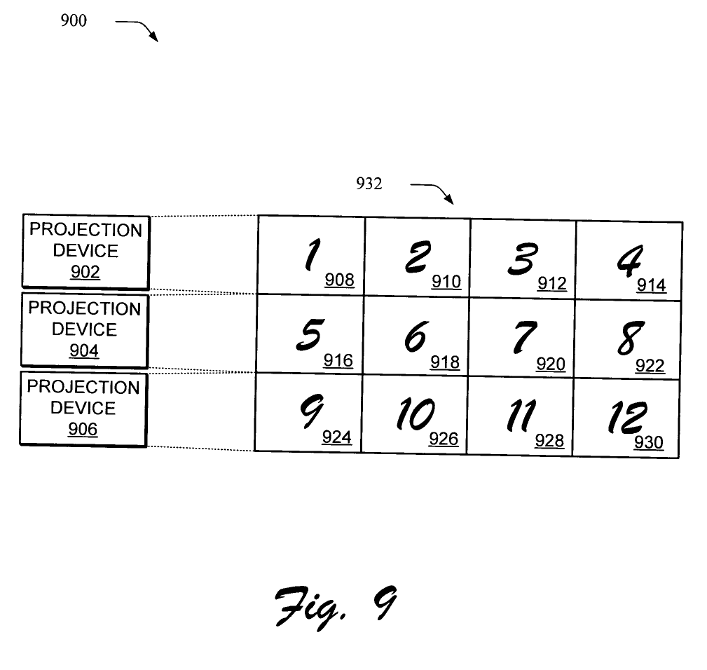

As shown in FIG. 7, the first and second sub-images 202, 204 were rotated to provide respective 3:4 aspect ratios that were used to form the image 702 having a 4:3 aspect ratio. A variety of other aspect ratios may also be provided. For example, FIG. 8 is an illustration of an exemplary embodiment 800 of the present invention showing first and second sub-images 202, 204 each having an aspect ratio and a resolution that are utilized to provide an image 802 composed of the sub-images having a different aspect ratio and resolution than each of the first and second sub-images 202, 204. In this embodiment, the first and second sub-image 202, 204 have a SVGA resolution that is provided in a 4:3 aspect ratio. The first and second sub-images 202, 204 are displayed adjacent to each other to provide the image 802 having a 16:9 aspect ratio and a resolution of 1067 by 600. Portions of the output of the first and second sub-images 202, 204 that are not utilized to display the image 802 as shown by the black rectangles 804.

FIG. 9 is an illustration of an exemplary embodiment 900 of the present invention showing a plurality of projection devices 902, 904, 906 each providing adjacent display of sequential sub-images 908-930 to provide a single image 932. Each of the projection devices 902, 904, 906 provides a portion of the single image 932. For example, projection device 902 provides adjacent and sequential display of sub-images 908, 910, 912, 914 that display, respectively, “1”, “2”, “3”, and “4”. Projection device 904 provides adjacent and sequential display of sub-images 916, 918, 920, 922 that display, respectively, “5”, “6”, “7”, and “8”. Projection device 906 provides adjacent and sequential display of sub-images 924, 926, 928, 930 that display, respectively, “9”, “10”, “11”, and “12”. The sub-images 908-930 provide a single image 932 that includes a display of the numbers “1” through “12”. Thus, as shown in FIG. 9, projection devices 902-906 may display different numbers of sequential sub-images, and multiple projection devices 902-906 may be utilized to provide a single image, with each of the projection devices 902-906 providing at least a portion of the image 932.

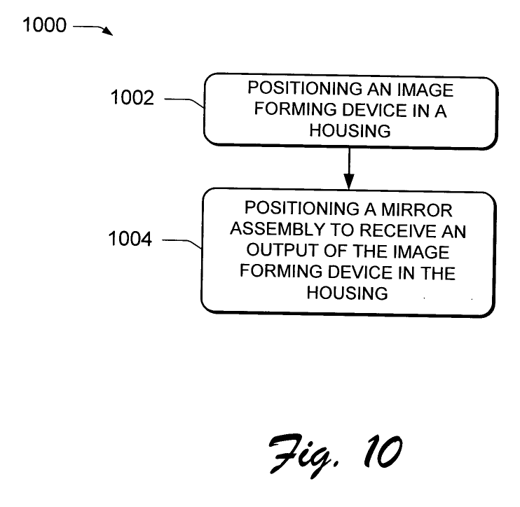

FIG. 10 is a flow chart depicting a procedure 1000 of an exemplary embodiment of the present invention wherein a projection device is produced that provides for adjacent and sequential display of sub-images. At block 1002, an image forming device is positioned in a housing. The image forming device may include components that are utilized to form an image, such as a digital micromirror device (DMD), a liquid crystal display (LCD), a grating light valve (GLV), a liquid crystal on silicon (LCOS) device, a cathode ray tube (CRT), and the like. The image forming device is configured to provide an output of sequential sub-images that form an image. For example, the sequential sub-images may form a portion of a single still image. The single still image may be one of a plurality of still images that are output by the image forming device to provide a moving scene.

At block 1004, a mirror assembly is positioned with respect to the output of the image forming device in the housing. The mirror assembly is configured to provide adjacent display of the sequential sub-images that are output by the image forming device such that an image that includes both of the sequential sub-images is viewable by a human eye. To provide the adjacent display, the mirror assembly may include first and second pathways for light to be displayed on adjacent portions of a screen. A mirror is utilized to control which of the first and second pathways is accessible by light that is output by the image forming device. The mirror may be configured in a variety of ways, such as a rotating mirror having a transparent portion and a reflective portion, a mirror that is configured to alternate between a reflective state and a transparent state, a moving mirror that is movable between first and second positions, and so on.

Although the invention has been described in language specific to structural features and methodological steps, it is to be understood that the invention defined in the appended claims is not necessarily limited to the specific features or steps described. Rather, the specific features and steps are disclosed as preferred forms of implementing the claimed invention.

1. A display device comprising:
an image forming device for providing sequential sub-images that compose at least a portion of an image; and
a mirror assembly for providing adjacent display of the sequential sub-images, one to another, such that each said sub-image in the portion of the image appears simultaneously to the human eye.

2. A display device as described in claim 1, wherein the image forming device includes a component selected from the group consisting of:
a digital micromirror device (DMD);
a liquid crystal display (LCD);
a grating light valve (GLV);
a liquid crystal on silicon (LCOS) device; and
a cathode ray tube (CRT).

3. A display device as described in claim 1, wherein the mirror assembly further comprises a device selected from the group consisting of:
a rotating mirror device having a transparent portion and a mirrored portion;
a moving mirror that is movable between first and second positions; and
a mirror device that is configured to alternate between a reflective state and a transparent state.

4. A display device as described in claim 1, wherein:
the image forming device has a first resolution; and
the portion of the image provided by the adjacent display of the sequential sub-images has a second resolution that is higher that the first resolution.

5. A display device as described in claim 4, wherein at least one of the first and second resolutions is selected from the group consisting of:
a video graphics array (VGA) resolution;
a super video graphics array (SVGA) resolution;
an extended graphics array (XGA) resolution;
an ultra extended graphics array (UXGA) resolution; and
a quantum extended graphics array (QXGA) resolution.

6. A display device as described in claim 1, wherein the adjacent display of the sequential sub-images is provided such that each said sub-image does not substantially overlap, one to another.

7. A display device as described in claim 1, wherein the image is a still image.

8. A display device as described in claim 1, wherein the image is one of a plurality of still images such that the plurality of still images provides a moving scene when displayed in sequence.

9. A method comprising:
in a projection device including:
an image forming device for providing first and second sequential sub-images that compose an image; and
a mirror assembly for providing sequential adjacent display of the first and second sequential sub-images,
displaying, by the mirror assembly, the first sequential sub-image on a first portion of a screen; and
displaying, by the mirror assembly, the second sequential sub-image on a second portion of the screen that is adjacent to the first portion,
wherein the first and second sub-images are displayed by the mirror assembly such that the image is viewable by a human eye.

10. A method as described in claim 9, wherein the image is a still image.

11. A method as described in claim 9, further comprising:
displaying, by the mirror assembly, a third sequential sub-image of an additional image on the first portion of the screen; and
displaying, by the mirror assembly, a fourth sequential sub-image of the additional image on the second portion of the screen,
wherein the third and fourth sequential sub-images are displayed by the mirror assembly such that the additional image is viewable by the human eye after the image including the first and second sequential sub-images is displayed.

12. A method as described in claim 9, wherein:
the mirror assembly includes a rotating mirror device having a transparent portion and a reflective portion;
the displaying of the first sequential sub-image is provided when the transparent portion is disposed in a light path of the image forming device; and
the displaying of the second sequential sub-image is provided when the reflective portion is disposed in a light path of the image forming device.

13. A method as described in claim 9, wherein:
the mirror assembly includes a moving mirror that is movable between first and second positions;
the displaying of the first sequential sub-image is provided when the moving mirror is positioned at the first position; and
the displaying of the second sequential sub-image is provided when the moving mirror is positioned at the second position.

14. A method as described in claim 9, wherein:
the mirror assembly includes a mirror device that is configured to alternate between a reflective state and a transparent state;
the displaying of the first sequential sub-image is provided when the mirror is configured in the reflective state; and
the displaying of the second sequential sub-image is provided when the mirror is configured in the transparent state.

15. A method as described in claim 9, wherein the image forming device includes a component selected from the group consisting of:
a digital micromirror device (DMD);
a liquid crystal display (LCD);
a grating light valve (GLV);
a liquid crystal on silicon (LCOS) device; and
a cathode ray tube (CRT).

16. A method as described in claim 9, wherein the first and second portions of the screen do not substantially overlap, one to another.

17. A method as described in claim 9, wherein:
the image forming device has a first resolution; and
the image provided by adjacent display of the sequential sub-images has a second resolution that is higher that the first resolution.

18. A projection device produced by a method comprising:
positioning, in a housing, an image forming device that is configured to provide an output; and
positioning, in the housing, a mirror assembly with respect to the output of the image forming device,
wherein the mirror assembly is configured to provide an adjacent display of sequential sub-images, one to another, that are output by the image forming device such that an image that includes the sequential sub-images is viewable by a human eye.

19. A projection device produced by the method as described in claim 18, wherein the image forming device includes a component selected from the group consisting of:
a digital micromirror device (DMD);
a liquid crystal display (LCD);
a grating light valve (GLV);
a liquid crystal on silicon (LCOS) device; and
a cathode ray tube (CRT).

20. A projection device produced by the method as described in claim 18, wherein the mirror assembly further comprises a device selected from the group consisting of:
a rotating mirror device having a transparent portion and a mirrored portion;
a moving mirror that is movable between first and second positions; and
a mirror device that is configured to alternate between a reflective state and a transparent state.

21. A projection device produced by the method as described in claim 18, wherein:
the image forming device has a first resolution; and
the portion of the image provided by the adjacent display of the sequential sub-images has a second resolution that is higher that the first resolution.

22. A projection device produced by the method as described in claim 21, wherein at least one of the first and second resolutions is selected from the group consisting of:
a video graphics array (VGA) resolution;
a super video graphics array (SVGA) resolution;
an extended graphics array (XGA) resolution;
an ultra extended graphics array (UXGA) resolution; and
a quantum extended graphics array (QXGA) resolution.

23. A projection device produced by the method as described in claim 18, wherein the image is a still image.

24. A projection device produced by the method as described in claim 18, wherein the image is one of a plurality of still images such that the plurality of still images provides a moving scene when displayed in sequence.

25. A projection device produced by the method as described in claim 18, wherein the adjacent display of the sequential sub-images is provided such that each said sub-image does not substantially overlap, one to another.

26. A projection device comprising:
means for providing sequential sub-images that compose at least a portion of an image; and
means for providing an adjacent display of the sequential sub-images, one to another, such that each said sub-image in the portion of the image appears simultaneously to the human eye.

27. A projection device as described in claim 26, wherein the sequential sub-image providing means include an image forming device.

28. A projection device as described in claim 26, wherein the adjacent display providing means include a mirror assembly.
